(19) United States
(12) Patent Application Publication
(10) Pub. No.: US 2026/0179655 A1
(43) Pub. Date: Jun. 25, 2026

(54) STORAGE MEDIUM STORING PROGRAM, SERVER, AND LABEL DATA SHARING SYSTEM

(71) Applicant: BROTHER KOGYO KABUSHIKI KAISHA, Nagoya (JP)

(72) Inventor: Ryoji BAN, Kiyosu (JP)

(21) Appl. No.: 19/458,509

(22) Filed: Jan. 23, 2026

Related U.S. Application Data
(63) Continuation of application No. PCT/JP2024/027696, filed on Aug. 2, 2024.

(30) Foreign Application Priority Data
Aug. 30, 2023 (JP) 2023-139808

(51) Int. Cl. G11B 27/034; G06F 16/958; G06F 21/10; G06Q 30/06

(52) U.S. Cl. CPC G11B 27/034; G06F 16/958; G06F 21/10; G06Q 30/06

(57) ABSTRACT

A set of program instructions, when executed by a computer of a server, causes the server to perform: in a case where label data is uploaded from a first information processing apparatus, storing the uploaded label data in a label database in association with content information indicating a content included in the uploaded label data; in a case where one of one or more contents stored in a content database is selected by a second information processing apparatus, extracting label data associated with content information indicating the selected content from among one or more label data stored in the label database; and presenting the extracted label data to the second information processing apparatus; and in a case where a download instruction of the selected content is received from the second information processing apparatus, transmitting the selected content to the second information processing apparatus.

### REFERENCE TO RELATED APPLICATIONS

This is a Continuation Application of International Application No. PCT/JP2024/027696 filed on Aug. 2, 2024, which claims priority from Japanese Patent Application No. 2023-139808 filed on Aug. 30, 2023. The entire content of each of the prior applications is incorporated herein by reference.

### BACKGROUND ART

A content server that stores various content data is known.

### SUMMARY

As a system for utilizing content data, a server for storing content data is prepared on the Internet, the content data is posted, that is, uploaded from a user device to the server, and the content data is downloaded to another user device.

For example, in a point management system, when photo data is uploaded from a PC of user A to a WWW server, and the photo data is purchased and downloaded from the WWW server by a PC of user B, points are given to the user B as the purchasing user according to the purchase amount, and points are also given to the user A as the poster according to the data size of the photo data when the photo data is uploaded or downloaded.

In recent years, systems for utilizing label data used for printing labels by label printers have been studied. The label data may be a combination of various contents, and users create a wide variety of label data by using the contents. In such a system, in order to utilize label data, many users utilize contents that are usable in label data. There is room for improvement in promoting the use of content.

In view of the foregoing, an example of an object of this disclosure is to realize a technology for promoting the use of contents in a system for using label data.

According to one aspect, this specification discloses a non-transitory computer-readable storage medium storing a set of program instructions for a server configured to access a label database in which one or more label data are stored and a content database in which one or more contents are stored. The one or more label data are printable by a label printer. The one or more contents are usable in the one or more label data. The set of program instructions, when executed by a computer of the server, causes the server to perform, in a case where label data is uploaded from a first information processing apparatus, storing the uploaded label data in the label database in association with content information indicating a content included in the uploaded label data. Thus, the uploaded label data is stored in the label database in association with content information indicating a content included in the uploaded label data. The set of program instructions, when executed by the computer of the server, causes the server to perform, in a case where one of the one or more contents stored in the content database is selected by a second information processing apparatus, extracting label data associated with content information indicating the selected content from among the one or more label data stored in the label database; and presenting the extracted label data to the second information processing apparatus. Thus, label data associated with content information indicating the selected content is extracted from among the one or more label data stored in the label database, and the extracted label data is presented to the second information processing apparatus. The set of program instructions, when executed by the computer of the server, causes the server to perform, in a case where a download instruction of the selected content is received from the second information processing apparatus, transmitting the selected content to the second information processing apparatus. Thus, the selected content is transmitted to the second information processing apparatus.

According to the technique disclosed in this specification, label data uploaded from various users is stored (registered) in the label database in association with content information of a content included in the label data, and when a selection for downloading a content is received from a certain user, label data including the selected content is extracted from the label database and presented (suggested) to the user, which enables the user who has selected the content to easily imagine the usage mode (usage example) of the content based on the label data created by another user, and download of the contents is promoted. That is, the use of contents is promoted.

A server and a label data sharing system for implementing the functions of the above aspect are also provided.

### BRIEF DESCRIPTION OF DRAWINGS

FIG. 1 illustrates a label data sharing system.

FIG. 2 illustrates electrical configurations of a label management server and a print log server.

FIG. 3A illustrates an example of user-related information stored in a user database.

FIG. 3B illustrates an example of posted label related information stored in a posted label database.

FIG. 3C illustrates an example of content-related information stored in a content database.

FIG. 3D illustrates an example of print log-related information stored in a print log database.

FIG. 4 is a sequence chart illustrating an example of a label posting process.

FIG. 5 illustrates a terminal when a label is posted.

FIG. 6 is a sequence chart illustrating an example of a content data download process.

FIG. 7A illustrates a terminal when content data is downloaded.

FIG. 7B illustrates the terminal when the content data is downloaded.

FIG. 8 is a sequence chart illustrating an example of a content data download process.

### DESCRIPTION

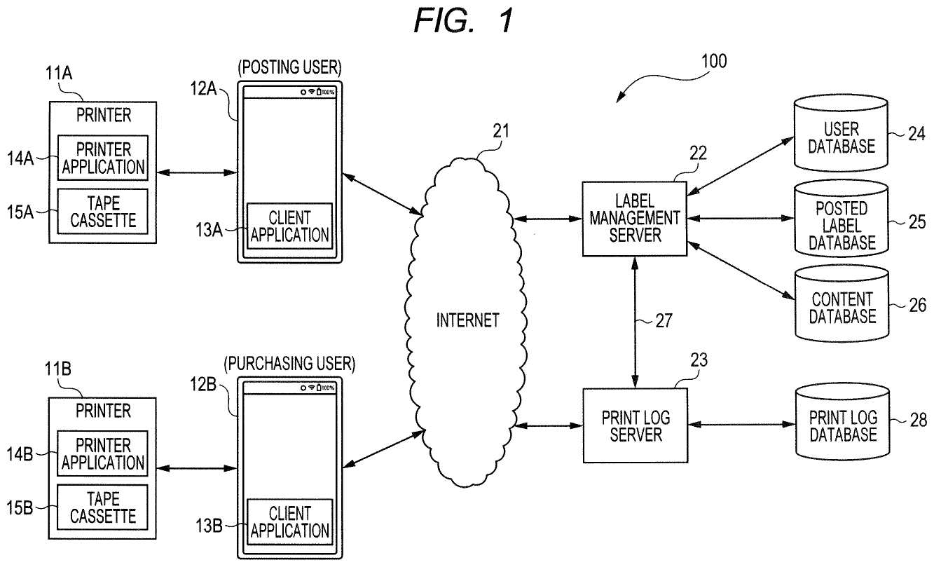

A label data sharing system 100 according to an embodiment will be described in detail below with reference to the drawings. FIG. 1 schematically shows the label data sharing system 100.

As shown in FIG. 1, the label data sharing system 100 of this embodiment is a system provided to a user by the vendor (manufacturer) of a printer 11A and a printer 11B. In the label data sharing system 100 of this embodiment, the owner or user (hereinafter referred to as user) of the printer 11A or 11B posts (that is, uploads) label data that is printed by the printer 11A or 11B to a label management server 22 from a terminal 12A or a terminal 12B possessed by the user. In the label data sharing system 100 of this embodiment, the user of the printer 11A or 11B downloads label data from the label management server 22 to the terminal 12A or the terminal 12B, and then print the label data by using the printer 11A or the printer 11B connected to the terminal 12A or the terminal 12B to create a label. The terminal 12A is an example of a first information processing apparatus, and the terminal 12B is an example of a second information processing apparatus.

The terminals 12A and 12B are smartphones owned by the user, but may be tablets or personal computers. The terminals 12A and 12B store various application programs (hereinafter referred to as applications), for example, client applications 13A and 13B provided to the user by the vendors of the printers 11A and 11B. The client applications 13A and 13B have functions for creating and editing labels on the terminals 12A and 12B. The client applications 13A and 13B have a function for uploading created label data to the label management server 22.

The client applications 13A and 13B have a function for downloading label data from the label management server 22. The client applications 13A and 13B have a function for printing label data created on the terminals 12A and 12B and downloaded label data by using the printers 11A and 11B. The printers 11A and 11B may be collectively referred to as “printer 11” when there is no need to distinguish each printer. The terminals 12A and 12B may be collectively referred to as “terminals 12” when there is no need to distinguish each terminal. The client applications 13A and 13B may be collectively referred to as “client application 13” when there is no need to distinguish each client application.

The printers 11A and 11B store printer applications 14A and 14B for controlling the printing of the printers 11A and 11B. Tape cassettes 15A and 15B are mounted to the printers 11A and 11B, and long tapes (not shown) for printing labels are wound in the tape cassettes 15A and 15B. The printer is an example of a label printer, and the tape is an example of a print medium.

The printer 11 is a label printer capable of printing labels, but may be an inkjet printer or a laser printer. The printer 11 is connected to the terminal 12 by wireless LAN communication such as Wi-Fi or short-range wireless communication such as Bluetooth. Alternatively, the printer 11 and the terminal 12 may be connected by wire using the USB communication standard. The “Wi-Fi is a registered trademark of Wi-Fi Alliance. The “Bluetooth” is a registered trademark of Bluetooth SIG, Inc.

Next, the label management server 22 and a print log server 23 constituting the label data sharing system 100 of this embodiment will be described. The label management server 22 and the print log server 23 may be connected to each other via Internet 21 or a wired LAN network 27. A user database 24, a posted label database 25, and a content database 26 are connected to the label management server 22 so as to be accessible. A print log database 28 is connected to the print log server 23 so as to be accessible. The label management server is an example of a server.

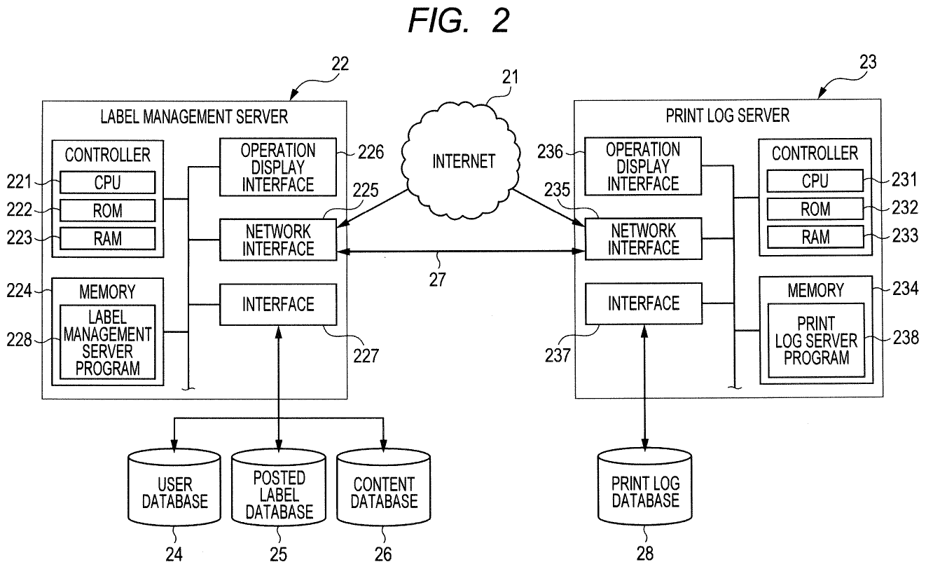

As shown in FIG. 2, the label management server 22 includes a CPU 221, a ROM 222, a RAM 223, a memory (storage) 224, a network interface 225, an operation display interface 226, and an interface 227. The ROM 222 stores a start program for starting up the label management server 22. The RAM 223 is used as a work area when various processes are performed or as a storage area for temporarily storing data.

The memory 224 is an HDD or a flash memory, for example, and stores a label management server program 228 and various processing programs.

The CPU 221 executes various processes according to programs read from the ROM 222 and the memory 224.

In this embodiment, the network interface 225 is an interface of a communication standard of a wired LAN. Alternatively, the network interface 225 may be an interface of a wireless LAN communication standard such as Wi-Fi, an interface of a USB communication standard, or an interface of a short-range wireless communication standard such as Bluetooth. The network interface 225 is connected to the Internet 21.

The operation display interface 226 is, for example, a display or a touch panel arranged on the display. The display displays various information, and the touch panel accepts input from the user.

In this embodiment, the interface 227 is an interface of a communication standard of a wired LAN, and is connected to the user database 24, the posted label database 25, and the content database 26. The user database 24, the posted label database 25, and the content database 26 may be provided in the label management server 22. The posted label database is an example of a label database.

As shown in FIG. 2, the print log server 23 includes a CPU 231, a ROM 232, a RAM 233, a memory (storage) 234, a network interface 235, an operation display interface 236, and an interface 237. The ROM 232 stores a startup program for starting up the print log server 23. The RAM 233 is used as a work area when various processes are performed or as a storage area for temporarily storing data.

The memory 234 is an HDD or a flash memory, for example, and stores a print log server program 238 and various processing programs.

The CPU 231 executes various processes according to programs read from the ROM 232 and the memory 234.

In this embodiment, the network interface 235 is an interface of a communication standard of a wired LAN. Alternatively, the network interface 235 may be an interface of a wireless LAN communication standard such as Wi-Fi, an interface of a USB communication standard, or an interface of a short-range wireless communication standard such as Bluetooth. The network interface 235 is connected to the network interface 225 of the label management server 22 via the wired LAN network 27.

The operation display interface 236 is, for example, a display or a touch panel arranged on the display. The display displays various information, and the touch panel accepts input from the user.

In this embodiment, the interface 237 is an interface of a communication standard of a wired LAN, and is connected to the print log database 28. The print log database 28 may be included in the print log server 23.

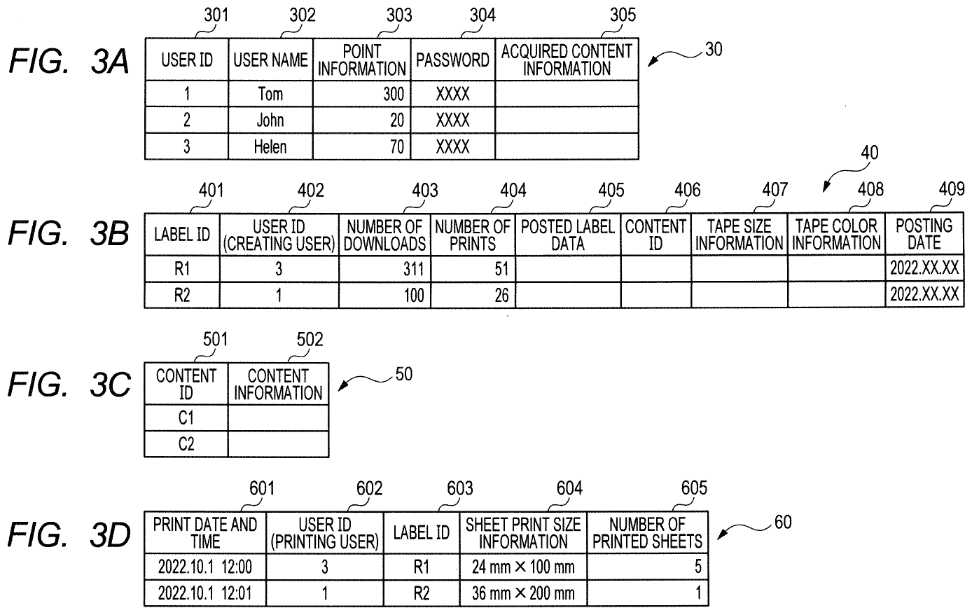

The user database 24 stores user related information 30 shown in FIG. 3A as table-format data. The user related information 30 includes a user ID 301, a user name 302, point information 303, a password 304, and acquired content information 305, for each user.

The user ID 301 is identification information for identifying a user to whom the label data sharing system 100 of this embodiment is provided, and identifies a user who uses the terminal 12. The user name 302 is a name, nickname, address, contact address, or mail address, for example, of an individual or a group (corporation) of the user to whom the label sharing service of this embodiment is provided. When a label is posted for the first time using the label data sharing system 100 of this embodiment, a user ID for identifying a user who posts the label is newly set and additionally stored in the user ID 301. Further, a user name and so on input by the user on the terminal 12 at the time of posting is additionally stored in the user name 302 corresponding to the newly set user ID.

The point information 303 is information indicating a held point which is a point in the label data sharing system 100 of this embodiment and which is a point currently held by the user. The held points are usable in place of cash when purchasing contents, printing paper, and so on using the label data sharing system 100 of this embodiment.

In the label data sharing system 100 of this embodiment, each time the posted label data is downloaded or printed by a user other than the posting user, the value of the point information 303 of the user who posted the posted label data is added. Although the detailed description of the addition method is omitted, the addition of the value of the point information 303 is performed based on a user ID 402, a number of downloads 403, and a number of prints 404, for example, of posted label related information 40 described later.

The password 304 is a password stored in the user name 302 and set by each user. The acquired content information 305 stores a content ID of a content purchased by the user.

The posted label database 25 stores the posted label related information 40 shown in FIG. 3B as table-format data. The posted label related information 40 includes, for each label data posted in the label data sharing system 100 of this embodiment, a label ID 401, a user ID 402, a number of downloads 403, the number of prints 404, posted label data 405, a content ID 406, tape size information 407, tape color information 408, a posting date 409, printer model number information (not shown) set for printing the posted label data, and version information (not shown) of the client application 13 of the terminal 12 that created the posted label data.

The label ID 401 is a serial number sequentially assigned to each label data registered in the posted label database 25 in the label data sharing system 100 of this embodiment. The user ID (creating user) 402 is the user ID 301 of the user who has posted the label data using the label data sharing system 100 of this embodiment. The number of downloads 403 is the number of times the label data posted by the user has been downloaded. The number of prints 404 is the number of times of printing of the label data posted by the user.

The posted label data 405 indicates the structure of the label. More specifically, the label data includes fonts, emojis (pictographs), character images, decoration images, frames, contents, and layout information of these elements. The content ID 406 stores the content ID of the content included in the posted label data 405. The content ID is an example of content information.

The tape size information 407 stores information on the width and length of the tape set by the user who posted the label data. The tape color information 408 stores information on the color of the tape set by the user who posted the label data. The posting date 409 is the date when the label data is posted by the user.

The content database 26 stores content-related information 50 shown in FIG. 3C as table-format data. The content-related information 50 includes a content ID 501 and content information 502. The content ID 501 is a serial number sequentially assigned to each content registered in the content database 26 in the label data sharing system 100 of this embodiment. The content information 502 stores content data provided to the user by the vendor (manufacturer) of the printer 11A or the printer 11B. The content data may be posted by the user using the label data sharing system 100 of this embodiment. The content data includes art such as special fonts, emojis (pictographs), special frames, character images, and decoration images.

The print log database 28 stores the print log related information 60 shown in FIG. 3d as a table. The print log related information 60 includes a print date and time 601, a user ID (purchasing user) 602, a label ID 603, sheet print size information 604, and a number of printed sheets 605.

The print date and time 601 is the date and time when the label is printed by the printer 11 in the label data sharing system 100 of this embodiment. The user ID (purchasing user) 602 is the user ID 301 of the user who printed the label by the printer 11. The label ID 603 is the label ID 401 of the label printed by the printer 11. The sheet print size information 604 is information on the print size of a print sheet (label) when a user prints by using the printer 11 in the label data sharing system of this embodiment, that is, information on the width and length of a print sheet in this embodiment. The number of printed sheets 605 is the number of printed sheets of the label printed by the printer 11.

In the label data sharing system 100 of this embodiment, the number of prints 404 of the posted label related information 40 is updated based on the label ID 603, the number of printed sheets 605, and so on of the print log related information 60. The update may be periodically performed at a particular interval, or may be performed each time the print log related information 60 is updated.

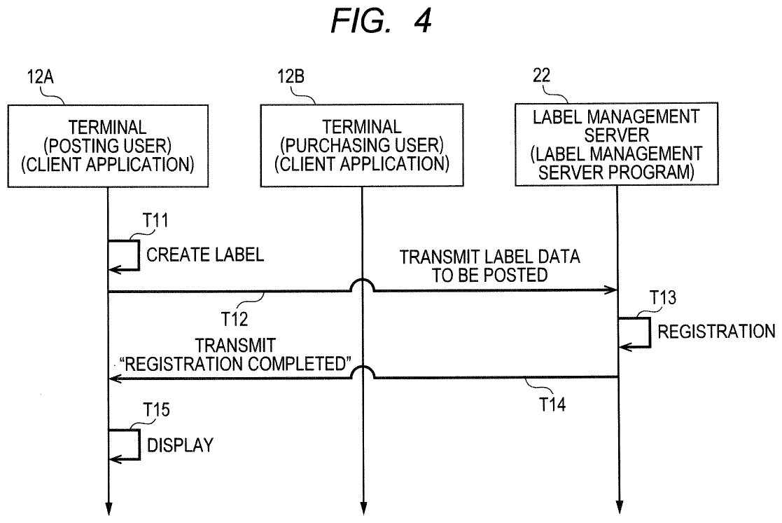

Next, an example of a label data posting process by the label management server program 228 of the label management server 22 according to this embodiment will be described with reference to the sequence chart of FIG. 4. FIG. 4 includes the operation of the client application 13 of the terminal 12.

Each processing step in this embodiment basically indicates processing of the CPU 221 mainly according to an instruction described in a program such as the label management server program 228. The processing by the CPU 221 includes hardware control using an API of an OS. In this specification, the operation of each program will be described without describing the OS in detail.

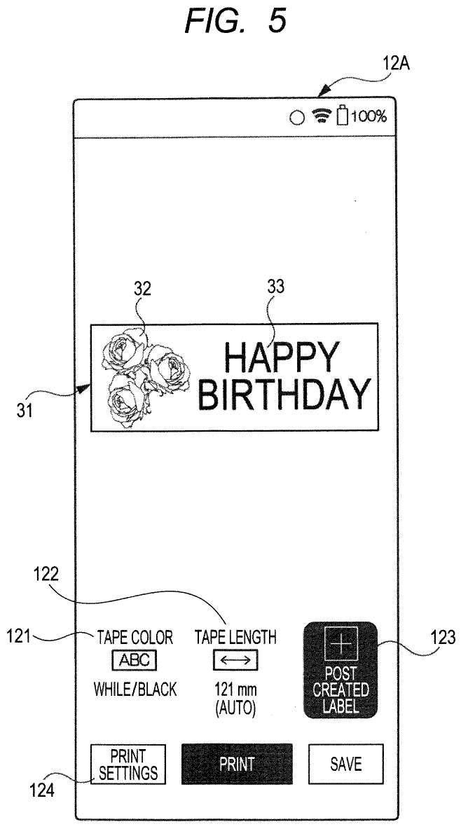

In the label posting process of this embodiment, first, a user who intends to post the label data (hereinafter referred to as a “posting user”) starts the client application 13A of the terminal (posting user) 12A, and then, on the terminal (posting user) 12A, the client application 13 of the terminal (posting user) 12A displays an editing screen for creating the label data 31 as shown in FIG. 5, for example, and accepts creation of the label data 31 (step 11 (hereinafter referred to as T11)). The label data 31 shown in FIG. 5 includes content data 32 which has already been purchased by the posting user and text data 33 which the posting user manually inputs by himself or herself at the terminal (posting user) 12A. The content data 32 that the posting user has already purchased includes art such as special fonts, emojis (pictographs), character images, and decoration images. The text data 33 may be content composed of special fonts that the posting user has already purchased.

In addition, on the terminal (posting user) 12A, a “tape color” button 121 for setting the color information of the tape of the label data 31 created by the posting user, a “tape length” button 122 for setting the length of the tape of the label data 31, and so on are displayed.

The posting user sets the color of the tape of the label data 31 by touching the “tape color” button 121. The posting user sets the tape length of the label data 31 by touching the “tape length” button 122.

Thereafter, when the posting user touches a new posting button 123 displayed on the terminal (posting user) 12A, the client application 13A of the terminal (posting user) 12A transmits the user ID of the posting user, label data to be posted which is the label data 31 created by the posting user, the tape size information suitable for printing the label data 31 set by the posting user, the color information of the tape of the label data 31 set by the posting user, and so on to the label management server 22 (T12). For example, the label management server program 228 provides a web page for posting, displays the web page by the browser function of the client application 13A, inputs a user ID when logging in the label management server 22 through the web page, and then inputs a transmission (send) instruction of the label data 31 through the web page, whereby the posted label data and so on are uploaded to the label management server 22. Before transmitting the label data 31, a screen for attaching explanatory text about the label data 31 or a use-example image which is a photographic image using the label data 31 may be displayed, and the accepted supplementary data may be transmitted together with the label data 31.

Then, the label management server 22 which has received the label data 31 and so on transmitted from the terminal (posting user) 12A stores the received label data 31 and so on in the posted label database 25 (T13). Hereinafter, the label data stored in the posted label database 25 is also referred to as posted label data.

More specifically, the label management server 22 creates a new label ID and stores the label data in the posted label database 25 as a new label ID401 of the posted label related information 40. Then, in the table of the posted label related information 40 corresponding to the new label ID 401, the received user ID 301 of the posting user is stored as the user ID (creating user) 402, the received posted label data is stored as the posted label data 405, the content ID of the content data included in the received posted label data is stored as the content ID 406, the received tape size information is stored as the tape size information 407, the received tape color information is stored as the tape color information 408, and the date of posting is stored as the posting date 409. When the supplementary data is received together with the posted label data, the supplementary data is stored in association with the label ID of the posted label data.

Next, the label management server 22 transmits “registration completed” to the terminal (posting user) 12A (T14). Then, the terminal (posting user) 12A which has received the “registration completed” displays the fact that the registration of the posted label data is completed on the display, thereby notifying the posting user (T15). This enables the posting user to know that the posted label data 31 has been registered (stored) in the label data sharing system.

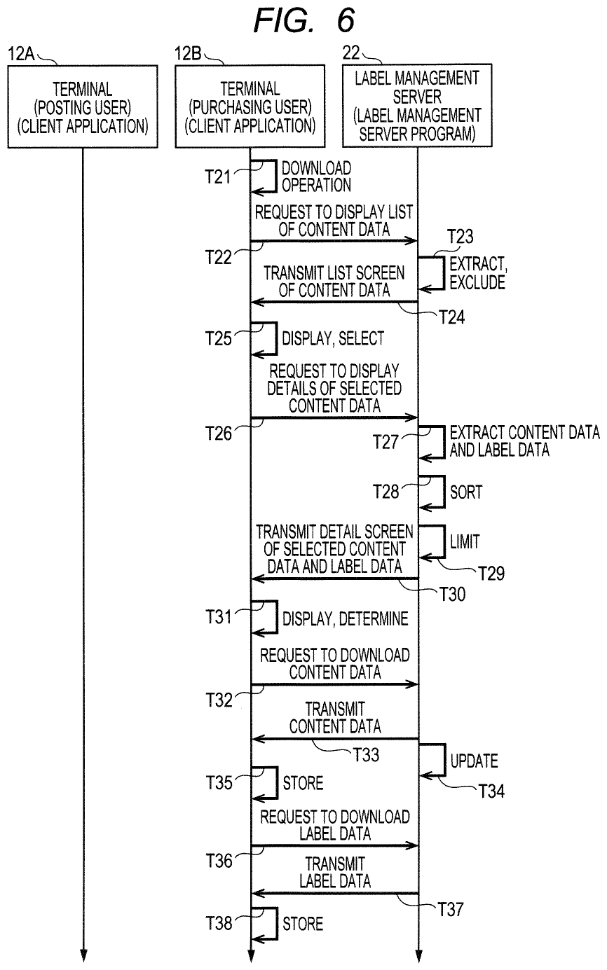

Next, an example of a content data download process provided to the user by the label management server program 228 of the label management server 22 according to this embodiment will be described with reference to the sequence chart of FIG. 6. FIG. 6 includes the operation of the client application 13B of the terminal 12B.

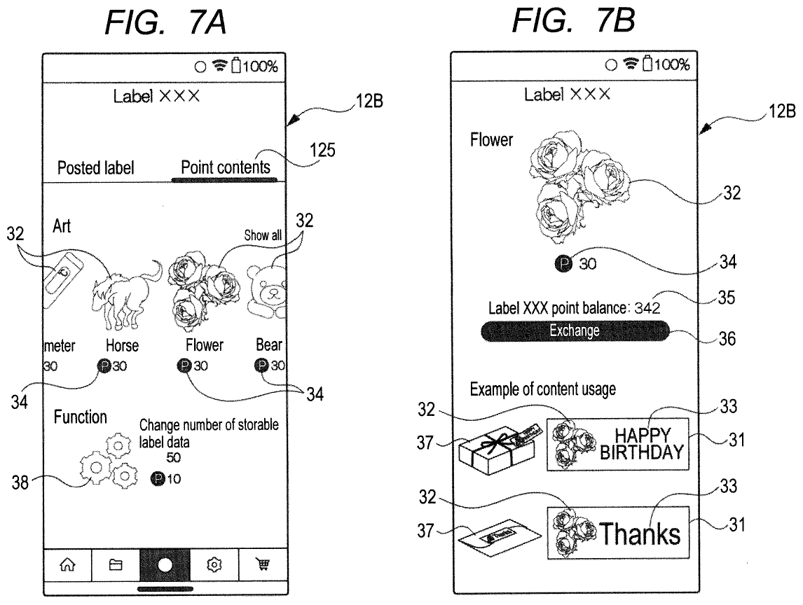

In the content data download process of this embodiment, first, when a user (hereinafter referred to as a purchasing user) who intends to download content data touches a “point contents” tab 125 (see FIG. 7) displayed on the terminal (purchasing user) 12B by the client application 13B of the terminal (purchasing user) 12B after starting the client application 13B of the terminal (purchasing user) 12B (T21), the terminal (purchasing user) 12B requests the label management server 22 to display a list of content data (T22). For example, the label management server program 228 provides a web page for log-in, the web page is displayed by the browser function of the client application 13B, and the user ID is input through the web page, whereby the user ID is transmitted. After the login is approved, when the “point contents” tab 125 displayed on the “terminal (purchasing user) 12B” is touched, the label management server 22 accepts a request for displaying a list of content data.

Next, the label management server 22 that has received the request for list display of content data extracts content data stored as the content information 502 of the content-related information 50 from the content database 26 together with the content ID stored as the content ID 501. At this time, in a case where the extracted content ID is already stored in the acquired content information 305 corresponding to the purchasing user in the user related information 30 shown in FIG. 3A, the label management server 22 excludes the content data and the content ID (T23).

As described above, in this embodiment, when the extracted content ID is already stored in the acquired content information 305 corresponding to the purchasing user as shown in FIG. 3A in T23, the content data and the content ID are excluded, thereby preventing presenting the acquired content data to the purchasing user by mistake. This prevents the purchasing user from purchasing the content data in duplicate.

At this time, the extracted content data and content ID may be sorted in descending order of the number of prints (that is, the content data having the largest number of prints comes first) based on the number of prints 404 and the content ID stored in the content ID 406 of the posted label related information 40 shown in FIG. 3B in T23, and the sorted content data and content ID may be presented (suggested) to the purchasing user.

In this case, the sorting may be performed by using the number of downloads 403 instead of the number of prints 404, or by using a value obtained by combining the number of downloads 403 and the number of prints 404.

As described above, in this embodiment, since the content data and the content ID extracted in T23 are sorted based on the number of downloads 403 and the number of prints 404 of the posted label related information 40 shown in FIG. 3B, the content data popular among the purchasing users are presented to the purchasing users with priority on the terminal (purchasing user) 12B, and convenience is improved.

Thereafter, the label management server 22 transmits a list screen showing a list of the content data extracted in T23 to the terminal (purchasing user) 12B (T24).

At this time, the list screen of the content data to be transmitted to the terminal (purchasing user) 12B may be a screen that displays thumbnail data and points used for purchase in addition to the title of the content data.

Then, the terminal (purchasing user) 12B which has received the list screen of the content data displays the received list screen on the display of the terminal (purchasing user) 12B (T25). For example, the label management server program 228 provides a web page for selecting content data, the web page is displayed by the browser function of the client application 13B, and a list screen of the content data 32 is displayed through the web page.

For example, as shown in FIG. 7A, a plurality of content data 32 are displayed on the display of the terminal (purchasing user) 12B together with the thumbnail and the title of the content data 32. In addition, a number of points 34 used to purchase the content data 32 is displayed below each content data 32.

When the purchasing user selects one of the plurality of content data 32 displayed on the display of the terminal (purchasing user) 12B, the user ID of the download executor (purchasing user) and the content ID of the selected content data 32 are input to the label management server 22 from the terminal (purchasing user) 12B, and the detailed display of the content data corresponding to the selected content data 32 is requested (T26).

Then, the label management server 22 which has received the request for detailed display of the content data extracts the record of the content data stored in the content information 502 from the content database 26 based on the requested content ID. The label management server 22 searches the posted label database 25 based on the requested content ID, and extracts the posted label data and the label ID stored in the posted label data 405 and the label ID 401, respectively, for the posted label data in which the content ID stored in the content ID 406 matches the content ID of the requested content data (T27). That is, the posted label data using the requested content data is extracted from the posted label database 25. T27 is an example of an extraction process.

Next, the label management server 22 sorts the extracted posted label data and label ID in the descending order of the number of prints based on the number of prints 404 of the posted label related information 40 shown in FIG. 3B (T28). In this case, the sorting may be performed by using the number of downloads 403 instead of the number of prints 404, or by using a value obtained by combining the number of downloads 403 and the number of prints 404. The number of downloads and the number of prints are examples of evaluation values.

The number of downloads 403 and the number of prints 404 may be values that are counted in a limited period. For example, each time the terminal 12 prints the label data, a record in which the label ID of the label data and the print date and time are associated with each other is stored as the print history in the print log database 28. Therefore, the print log database 28 may be referred to and the number of prints for the most recent one week or the most recent one year may be used for each label data.

In this way, in this embodiment, the posted label data having a large number of downloads and a large number of prints can be said to be the posted label data having a high popularity, and is highly likely to be a suitable use example of the content data. Therefore, by sorting and presenting the extracted posted label data in the order of popularity, the purchasing user easily imagines a suitable usage mode of the content data.

Next, the label management server 22 limits the sorted posted label data and label ID to the posted label data whose length is shorter than or equal to a threshold, based on the tape length information stored in the tape size information 407 of the posted label related information 40 shown in FIG. 3B (T29). That is, among the sorted posted label data and label ID, the posted label data having a length exceeding the threshold is excluded. The threshold may be set to any value such as 100 mm or 80 mm depending on the size of the screen of the terminal (purchasing user) 12B.

In this way, in this embodiment, the sorted posted label data is limited to the posted label data having a length shorter than or equal to the threshold, and therefore, the posted label data having a long length is not displayed. If the length of the posted label data is long, the entire posted label data cannot be shown in the screen of the terminal (purchasing user) 12B, and it becomes difficult for the user to check the posted label data. Thus, such posted label data is excluded from the label data shown to the user, which enables the purchasing user to check the usage mode (usage example) of the posted label data.

The label management server 22 may limit the number of the posted label data, which is limited in T29, to N in the order of popularity. The number N may be any value, for example, 10 or 20, depending on the screen size of the terminal (purchasing user) 12B or the function of the terminal (purchasing user) 12B. The number N may be a number set by the purchasing user.

In this way, in this embodiment, the number of the posted label data to be presented is set to be up to the top N of popularity, enabling the purchasing user to easily check the usage mode of the content data. That is, when the number of the posted label data to be presented is large, the display on the screen of the terminal (purchasing user) 12B becomes complicated, and it becomes difficult for the purchasing user to check the use mode of the content data. In this embodiment, such a problem is solved by setting an upper limit of the number of posted label data shown to the purchasing user.

In this embodiment, the label management server 22 limits the sorted posted label data to posted label data having a length shorter than or equal to a threshold in T29, and then limits the number of posted label data to N in the order of popularity, but the present disclosure is not limited to this. For example, the label management server 22 may be configured to limit the number of posted label data to N in order of popularity without executing a process of limiting the posted label data to those having a length shorter than or equal to a threshold. T28 and T29 may be performed in the reverse order.

Next, the label management server 22 transmits, to the terminal (purchasing user) 12B, information indicating the content of the content data requested to be displayed in detail and a detailed screen including the posted label data and the label ID limited to N items in the order of popularity (T30). In a case where the content data for which the detailed display is requested is stored in the posted label database 25 in association with a use-example image, the use-example image may be read out and included in the detailed screen. The processing in T30 is an example of a presentation (suggestion) process.

On the other hand, the terminal (purchasing user) 12B which has received the detailed screen from the label management server 22 displays the detailed screen on its display, for example, as shown in FIG. 7B (T31). Then, the download, that is, the purchase of the selected content data is accepted.

Specifically, the selected content data 32, the number of points 34 used to purchase the content data 32, and the number of points (point balance) 35 currently held by the purchasing user are displayed on the display of the terminal (purchasing user) 12B. A thumbnail of the posted label data 31 extracted in T27 is displayed below an “exchange” button 36. The plurality of posted label data 31 to be displayed may be displayed simultaneously or sequentially in accordance with a scroll operation. When the extracted posted label data 31 is associated with the use-example image, a use-example image 37 of the posted label data 31 is displayed on the left side of the displayed label data 31.

As described above, in this embodiment, the posted label data 31 using the selected content data 32 and the use-example image 37 of the posted label data 31 are displayed together with the selected content data 32, which enables the purchasing user to easily imagine the usage mode of the content data 32, and the purchase of the content data is promoted.

Next, when the purchasing user touches the “exchange” button 36, the terminal (purchasing user) 12B transmits a request for downloading the selected content data 32 to the label management server 22 (T32).

Next, when the download is requested, the label management server 22 transmits the selected content data 32 to the terminal (purchasing user) 12B (T33). The processing in T33 is an example of a content transmission process. In the user related information 30 shown in FIG. 3A, for a user whose user ID matches the received user ID, the label management server 22 subtracts the number of points stored in the point information 303 by the number of points used for the point exchange process. The label management server 22 stores the content ID of the content data 32 subjected to the point exchange process this time in the acquired content information 305 (T34).

The terminal (purchasing user) 12B which has received the content data stores the content data 32 in a nonvolatile memory (not shown) (T35).

In this embodiment, the content data 32 is purchased by the point exchange process by using the points owned by the download executor (purchasing user), but the content data 32 may be purchased by other payment methods.

In this way, in this embodiment, the posted label data 31 is stored in the posted label database 25 in association with the content ID of the content data 32 included in the posted label data 31, and when selection for downloading the content data 32 is received, the posted label data 31 including the selected content data 32 is extracted from the posted label database 25 and presented, which enables the purchasing user to easily imagine the usage mode of the content data 32 and the download of the content data 32 is promoted.

While the posted label data 31 extracted in T27 is being displayed on the detail screen as shown in FIG. 7B, the download of the displayed posted label data 31 may be accepted. In this case, the label management server 22 may be configured to receive a download instruction in a state where one or more posted label data 31 are selected via the detail screen, and when the download instruction is received from the purchasing user (T36), the label management server 22 transmits the posted label data of the selected one or more label data 31 to the terminal (purchasing user) 12B (T37), and the terminal (purchasing user) 12B stores the received posted label data in the memory (T38). In this case, since the displayed label data 31 is downloadable, the use of the content data including the target content is promoted.

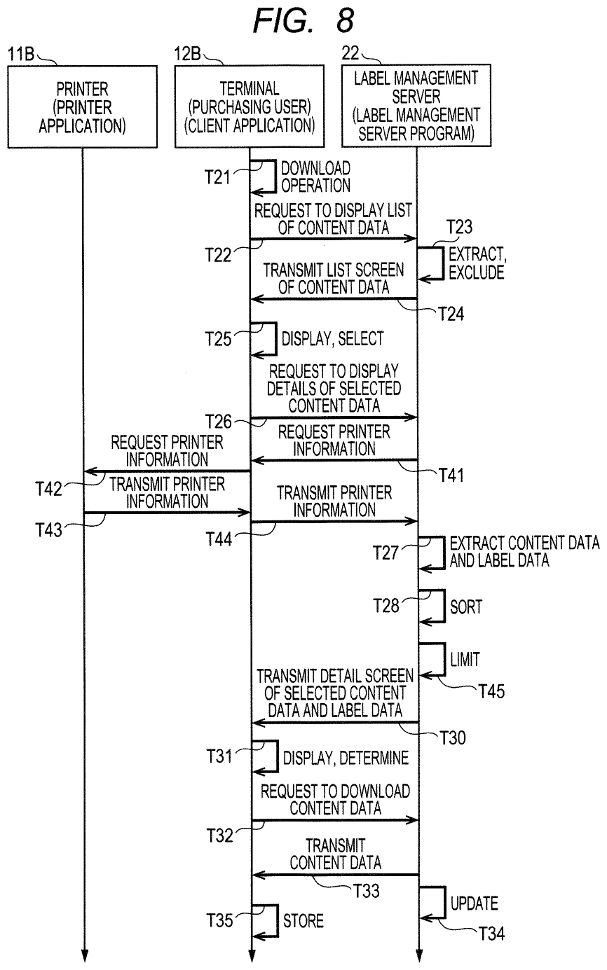

Next, a second embodiment will be described. In this embodiment, an example of a content data download process provided to a user by the label management server program 228 of the label management server 22 will be described with reference to a sequence chart of FIG. 8. FIG. 8 includes the operations of the printer application 14B of the printer 11B and the client application 13B of the terminal 12B. In the description, the same components as those in the first embodiment are denoted by the same reference numerals.

That is, in this embodiment, in T45, the label management server 22 limits the posted label data and its label ID extracted in T27 based on the printer information acquired from the printer 11B connected to the terminal (purchasing user) 12B.

In FIG. 8, when the label management server 22 receives a request for details of the content data corresponding to the selected content data 32 in T26, the label management server 22 requests the terminal (purchasing user) 12B for printer information (T41).

Next, the terminal (purchasing user) 12B which has received the request for printer information requests the printer information from the printer 11B connected to the terminal 12B (T42).

Next, the printer 11B which has received the request for the printer information collects the tape width information of the tape wound in the tape cassette 15B set in the printer 11B, the color information of the tape, the model number information of the printer 11B, and so on, and then transmits the set of information as the printer information to the terminal (purchasing user) 12B (T43).

Next, the terminal (purchasing user) 12B which has received the printer information transmitted from the printer 11B transmits the received printer information to the label management server 22, and the label management server 22 receives the printer information (T44). The processing in T44 is an example of a width acquisition process.

Next, the label management server 22 that has received the printer information limits the posted label data and its label ID extracted in T27 based on the printer information acquired from the printer 11B connected to the terminal (purchasing user) 12B (T45).

More specifically, in T45, the label management server 22 limits the posted label data and the label ID extracted in T27 to the posted label data in which width information matching the tape width information of the tape acquired from the printer 11B is stored in the tape size information 407. The width information stored in the tape size information is an example of first medium information, and the tape width information of the tape acquired from the printer is an example of second medium information.

In this case, it is difficult for the purchasing user to use the content when the tape width of the posted label data is different from the tape width of the tape set in the printer 11B. Thus, the posted label different from the tape width of the tape set in the printer 11B is excluded from the presentation (suggestion) target, which enables the purchasing user to easily imagine the usage mode of the content.

In T45, the label management server 22 limits the posted label data and the label ID extracted in T27 to the posted label data in which the tape color information matching the tape color information acquired from the printer 11B is stored in the tape color information 408. The color information stored in the tape color information is an example of the first medium information, and the tape color information acquired from the printer is an example of the second medium information.

In this case, by excluding the posted label data that does not match the characteristics (that is, the color of the tape) of the tape acquired from the terminal (purchasing user) 12B from the presentation target, more suitable label data is presented to the user.

In T45, the label management server 22 may limit the posted label data and the label ID extracted in T27 to posted label data in which the model number information matching the characteristic of the model number information of the printer 11B acquired from the printer 11B is stored in the posted label database 25. The model number information stored in the posted label database is an example of first printer information, and the printer model number information acquired from the printer is an example of second printer information.

In this case, by excluding the posted label data that does not include the characteristics matching the characteristics of the printer acquired from the terminal (purchasing user) 12B from the presentation target, more suitable posted label data is presented to the purchasing user. The model number information of the printer 11B may be the model number information of the printer 11B set in the client application 13B of the terminal (purchasing user) 12B. The model number of the printer 11B in the client application 13B of the terminal (purchasing user) 12B may be set after a “print settings” button 124 is touched.

In T45, the label management server 22 may limit the posted label data and the label ID extracted in T27 to the posted label data in which the version information matching the characteristic (for example, the version information) of the client application 13B acquired from the terminal (purchasing user) 12B is stored in the posted label database 25. The version information stored in the posted label database is an example of first application information, and the version information of the client application is an example of second application information.

In this case, by excluding the posted label data that does not include the characteristic matching the version information acquired from the terminal (purchasing user) 12B from the presentation target, more suitable posted label data is presented to the purchasing user.

In this embodiment, in T45, the label management server 22 may limit the posted label data and its label ID extracted in T27 by using one or a combination of the tape width information, the tape color information, and the model number information of the printer 11B among the printer information.

In this embodiment, in T45, the label management server 22 may execute the processing of T29 of the first embodiment, that is, the processing of limiting the sorted posted label data and the label ID to the posted label data having a length shorter than or equal to a threshold based on the tape length information stored in the tape size information 407 of the posted label related information 40 shown in FIG. 3B.

As described in detail above, in the label data sharing system 100 of the embodiment, the posted label data 31 is stored (registered) in the posted label database 25 in association with the content information of the content data 32 included in the posted label data 31, and when the selection for downloading the content data 32 is received, the posted label data 31 including the selected content data 32 is extracted from the posted label database 25 and presented (suggested) to the purchasing user. This enables the purchasing user to imagine the usage mode of the content, and the download of the content is promoted.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

For example, the number of printers connected to the terminal is not limited to the example shown in the figure, and may be two or more.

In the above-described embodiments, the user database 24, the posted label database 25, and the content database 26 are connected to the label management server 22 in an accessible manner, and the print log database 28 is connected to the print log server 23 in an accessible manner.

In the above-described embodiments, the label management server 22 is configured to request the terminal (purchasing user) 12B for printer information when the request for details of the content data corresponding to the selected content data 32 is received in T26. Alternatively, the terminal (purchasing user) 12B may be configured to transmit the printer information to the label management server 22 together with the user ID of the download executor (purchasing user) and the content ID of the selected content data 32 when the purchasing user selects one of the plurality of content data 32 displayed on the display of the terminal (purchasing user) 12B (T25).

In the above-described embodiments, the posted label data posted by the posting user is stored in the posted label database 25, but the posted label data may be label data prepared in advance by the vendor (manufacturer) of the printer 11A or the printer 11B.

In the above-described embodiments, the content data are art such as special fonts, emojis (pictographs), character images, and decoration images, but may include a function for changing the number of label data that are storable in the terminal 12. In this case, by touching a “change number of storable label data” button 38 shown in FIG. 7A and purchasing the function, the number of label data that are storable in the terminal 12 is increased.

In the above-described embodiments, the label management server 22 and the print log server 23 are provided separately, but the label management server 22 and the print log server 23 may be integrated into a single server.

In any sequence chart disclosed in the above-described embodiments, the execution order of any plurality of steps may be changed or may be performed in parallel as long as the steps do not contradict each other.

The processing disclosed in the above-described embodiments may be performed by a single CPU, multiple CPUs, hardware such as an ASIC, or a combination thereof. The processing disclosed in the embodiments may be realized in various forms such as a storage medium on which a program for executing the processing is recorded, a method for performing the processing, and so on.

1. A non-transitory computer-readable storage medium storing a set of program instructions for a server configured to access a label database in which one or more label data are stored and a content database in which one or more contents are stored, the one or more label data being printable by a label printer, the one or more contents being usable in the one or more label data, the set of program instructions, when executed by a computer of the server, causing the server to perform:
in a case where label data is uploaded from a first information processing apparatus, storing the uploaded label data in the label database in association with content information indicating a content included in the uploaded label data;
in a case where one of the one or more contents stored in the content database is selected by a second information processing apparatus,
extracting label data associated with content information indicating the selected content from among the one or more label data stored in the label database; and
presenting the extracted label data to the second information processing apparatus; and in a case where a download instruction of the selected content is received from the second information processing apparatus, transmitting the selected content to the second information processing apparatus.

2. The non-transitory computer-readable storage medium according to claim 1, wherein each of the one or more label data stored in the label database is associated with an evaluation value that indicates popularity;
wherein the extracting includes extracting a plurality of label data; and
wherein the presenting includes sorting the extracted plurality of label data by the popularity based on the evaluation value associated with the extracted plurality of label data, and presenting the sorted plurality of label data to the second information processing apparatus.

3. The non-transitory computer-readable storage medium according to claim 2, wherein the presenting includes sorting the extracted plurality of label data by the popularity based on the evaluation value associated with the extracted plurality of label data, selecting top N label data sorted by the popularity, and presenting the selected top N label data to the second information processing apparatus.

4. The non-transitory computer-readable storage medium according to claim 1, wherein the extracting includes extracting label data satisfying an extraction condition from among the one or more label data stored in the label database, the extraction condition being a condition for limiting a number of label data to be presented to the second information processing apparatus.

5. The non-transitory computer-readable storage medium according to claim 4, wherein the extraction condition is that a label length indicated in the label data is shorter than a threshold.

6. The non-transitory computer-readable storage medium according to claim 4, wherein the set of program instructions, when executed by the computer of the server, causes the server to perform:
acquiring a label width from the second information processing apparatus; and
wherein the extraction condition is that a label width indicated in the label data is same as the label width acquired from the second information processing apparatus.

7. The non-transitory computer-readable storage medium according to claim 4, wherein the label data includes first medium information indicating a characteristic of a print medium;
wherein the set of program instructions, when executed by the computer of the server, causes the server to perform:
acquiring second medium information indicating a characteristic of a print medium from the second information processing apparatus; and
wherein the extraction condition is that the characteristic indicated by the first medium information included in the label data is same as the characteristic indicated by the second medium information acquired from the second information processing apparatus.

8. The non-transitory computer-readable storage medium according to claim 4, wherein the label data includes first printer information indicating a characteristic of a printer; wherein the set of program instructions, when executed by the computer of the server, causes the server to perform:
acquiring second printer information indicating a characteristic of a printer from the second information processing apparatus; and
wherein the extraction condition is that the characteristic indicated by the first printer information included in the label data is same as the characteristic indicated by the second printer information acquired from the second information processing apparatus.

9. The non-transitory computer-readable storage medium according to claim 4, wherein the label data includes first application information indicating a characteristic of an editing application, the editing application being an application program for editing label data; wherein the set of program instructions, when executed by the computer of the server, causes the server to perform:
acquiring second application information indicating a characteristic of an editing application from the second information processing apparatus; and
wherein the extraction condition is that the characteristic indicated by the first application information included in the label data is same as the characteristic indicated by the second application information acquired from the second information processing apparatus.

10. The non-transitory computer-readable storage medium according to claim 1, wherein the set of program instructions, when executed by the computer of the server, causes the server to perform:
while the label data is being presented to the second information processing apparatus, receiving a download instruction of the presented label data; and
in response to receiving the download instruction of the presented label data from the second information processing apparatus, transmit the presented label data to the second information processing apparatus.

11. A server connectable to a first information processing apparatus and a second information processing apparatus via a network, the server configured to access a label database in which one or more label data are stored and a content database in which one or more contents are stored, the one or more label data being printable by a label printer, the one or more contents being usable in the one or more label data,
the server configured to:
in a case where label data is uploaded from the first information processing apparatus, storing the uploaded label data in the label database in association with content information indicating a content included in the uploaded label data;
in a case where one of the one or more contents stored in the content database is selected by the second information processing apparatus,
extracting label data associated with content information indicating the selected content from among the one or more label data stored in the label database; and
presenting the extracted label data to the second information processing apparatus; and
in a case where a download instruction of the selected content is received from the second information processing apparatus, transmitting the selected content to the second information processing apparatus.

12. The server according to claim 11, wherein each of the one or more label data stored in the label database is associated with an evaluation value that indicates popularity;
wherein the extracting includes extracting a plurality of label data; and
wherein the presenting includes sorting the extracted plurality of label data by the popularity based on the evaluation value associated with the extracted plurality of label data, and presenting the sorted plurality of label data to the second information processing apparatus.

13. The server according to claim 12, wherein the presenting includes sorting the extracted plurality of label data by the popularity based on the evaluation value associated with the extracted plurality of label data, selecting top N label data sorted by the popularity, and presenting the selected top N label data to the second information processing apparatus.

14. The server according to claim 11, wherein the extracting includes extracting label data satisfying an extraction condition from among the one or more label data stored in the label database, the extraction condition being a condition for limiting a number of label data to be presented to the second information processing apparatus.

15. The server according to claim 14, wherein the extraction condition is that a label length indicated in the label data is shorter than a threshold.

16. The server according to claim 14, wherein the server is configured to perform:
acquiring a label width from the second information processing apparatus; and
wherein the extraction condition is that a label width indicated in the label data is same as the label width acquired from the second information processing apparatus.

17. The server according to claim 14, wherein the label data includes first medium information indicating a characteristic of a print medium;
wherein the server is configured to perform:
acquiring second medium information indicating a characteristic of a print medium from the second information processing apparatus; and
wherein the extraction condition is that the characteristic indicated by the first medium information included in the label data is same as the characteristic indicated by the second medium information acquired from the second information processing apparatus.

18. The server according to claim 14, wherein the label data includes first printer information indicating a characteristic of a printer;
wherein the server is configured to perform:
acquiring second printer information indicating a characteristic of a printer from the second information processing apparatus; and
wherein the extraction condition is that the characteristic indicated by the first printer information included in the label data is same as the characteristic indicated by the second printer information acquired from the second information processing apparatus.

19. The server according to claim 11, wherein the server is configured to perform:
while the label data is being presented to the second information processing apparatus, receiving a download instruction of the presented label data; and
in response to receiving the download instruction of the presented label data from the second information processing apparatus, transmit the presented label data to the second information processing apparatus.

20. A label data sharing system comprising a first information processing apparatus, a second information processing apparatus, and a server, the first information processing apparatus and the second information processing apparatus being connectable to the server via a network, the server configured to access a label database in which one or more label data are stored and a content database in which one or more contents are stored, the one or more label data being printable by a label printer, the one or more contents being usable in the one or more label data, the first information processing apparatus configured to upload label data stored in the first information processing apparatus to the server;
the server configured to store the label data uploaded from the first information processing apparatus in the label database in association with content information indicating a content included in the uploaded label data;
the second information processing apparatus configured to select one of the one or more contents stored in the content database;
the server configured to:
in a case where one of the one or more contents stored in the content database is selected by the second information processing apparatus,
extract label data associated with content information indicating the selected content from among the one or more label data stored in the label database; and
present the extracted label data to the second information processing apparatus; and
the second information processing apparatus configured to download the selected content from the server.
